(19) United States
(12) Patent Application Publication
(10) Pub. No.: US 2026/0133467 A1
(43) Pub. Date: May 14, 2026

(54) FOUNDRY-FABRICATED SOURCES OF BROADBAND ENTANGLEMENT

(71) Applicant: UT-Battelle, LLC, Oak Ridge, TN (US)

(72) Inventors: Alexander Miloshevsky, Chattanooga, TN (US); Hsuan-Hao Lu, Oak Ridge, TN (US); Karthik V. Myilswamy, West Lafayette, IN (US); Lucas M. Cohen, West Lafayette, IN (US); Andrew M. Weiner, West Lafayette, IN (US); Joseph M. Lukens, West Lafayette, IN (US)

(21) Appl. No.: 19/384,469

(22) Filed: Nov. 10, 2025

Related U.S. Application Data
(60) Provisional application No. 63/719,017, filed on Nov. 11, 2024.

(51) Int. Cl. G02F 1/39; G02B 6/27; G02B 6/293; G02F 1/35; H04B 10/564; H04B 10/70; H04L 9/08

(52) U.S. Cl. CPC G02F 1/395; G02B 6/2726; G02B 6/2773; G02B 6/29338; G02F 1/3536; H04B 10/564; H04B 10/70; H04L 9/0858; G02F 2201/58

(57) ABSTRACT

Photonic integrated circuit(s) (PIC(s)), quantum transmitter(s) and quantum network(s) are provided. Polarization entangled photons, frequency entangled photons and/or polarization-frequency hyperentangled photons may be distributed from a quantum transmitter having one or more PICs. The PIC(s) may be capable of producing one, two or four polarization-entangled Bell State(s).

### CROSS-REFERENCE TO RELATED APPLICATIONS

This application claims the benefit of U.S. Provisional Application No. 63/719,017 filed on Nov. 11, 2024, which is incorporated by reference herein in its entirety.

### STATEMENT REGARDING FEDERALLY SPONSORED RESEARCH OR DEVELOPMENT

This invention was made with Government support under DE-AC05-00OR22725 awarded by U.S. Department of Energy. The Government has certain rights to this invention.

### FIELD OF THE DISCLOSURE

This disclosure relates to quantum communication and more specifically to quantum transmitter(s) which include a photonic integrated circuit for providing entangled photons.

### BACKGROUND

Distribution of entangled photons including hyperentangled photons has significant potential in quantum communication including protocols such as, but not limited to, dense coding and single-copy entanglement distillation. In order to achieve a commercially viable quantum network which may include a quantum internet, a stable and flexible way to distribute entangled photons between distant quantum resources is essential such that the quantum state of the entangled photons may be utilized.

A quantum transmitter must be flexible enough to distribute entanglement on demand to multiple-end users, adapt to user resource requirements, and maneuver unexpected disruptions to communication channels.

Certain known entangled photon transmitters use large and heavy optical components which are bulky and difficult to scale. To achieve a scalable quantum communications system, the size of the quantum transmitter should be reduced.

One such way to reduce the size is to have on-chip generation of the entanglement such as using a CMOS photonic integrated circuit (PIC). Known PICs have limitations in the entanglement. For example, a known PIC may use a microring resonator (MRR) to generate frequency entanglement. MRR enables resonantly enhanced spontaneous four-wave mixing (SFWM) or spontaneous parametric down-conversion (SPDC) for pair generation. However, while producing frequency-bin entanglement automatically, the direct generation of polarization entanglement in MRRs is complicated by the distinct spatial profiles and effective indices for orthogonal polarization modes, leading to mismatched spectral resonances for the different orthogonal polarization modes and preventing the direct generation of polarization entanglement.

One solution is to place the MRR in a fiber Sagnac loop to convert co-polarized but counter-propagating amplitudes into a polarization-entanglement, however, since off-chip fiber optics is used, this sacrifices compactness.

Another solution is to have separate MRRs coupled to the same waveguide, one aligned for a first polarization mode and another aligned for a second polarization mode (orthogonal to the first), however, such an approach requires tight fabrication tolerances for broadband operations, complicating the design and hindering scalability.

### SUMMARY

Accordingly, disclosed is a photonic integrated circuit (PIC) comprising a microring resonator (MRR), a first waveguide, a second waveguide and a polarization splitter rotator (PSR). The MRR is configured to receive first pump and second pump having a first polarization mode. The first pump and the second pump have a pump frequency f_{P} that matches a resonant frequency of the MRR. The MRR is configured to guide the first pump in a first direction through the MRR, and the second pump in a second direction through the MRR. The second direction is opposite to the first direction. The MRR is configured to produce, from the first pump, respective first frequency-correlated photon pairs via a nonlinear optical interaction supported by the MRR, subject to energy conservation. Each respective first frequency-correlated photon pair has a signal mode with a signal frequency f_{S} and idler mode with an idler frequency f_{I}. The MRR guides each respective first frequency-correlated photon pair in the first direction through the MRR. The MRR is configured to produce, from the second pump, respective second frequency-correlated photon pairs via the nonlinear optical interaction supported by the MRR, subject to energy conservation. Each respective second frequency-correlated photon pair has a signal mode with the signal mode frequency f_{S} and idler mode with the idler mode frequency f_{I}. The MRR guides each respective second frequency-correlated photon pair in the second direction through the MRR. The first waveguide is disposed upstream from the MRR. The first waveguide is evanescently coupled to the MRR. The first waveguide is configured to transfer the first pump and the second pump to the MRR. The first pump propagates in the second direction within the first waveguide, and the second pump propagates in the first direction within the first waveguide. The second waveguide is disposed downstream from the MRR. The second waveguide is evanescently coupled to the MRR. The second waveguide configured to receive the respective first frequency-correlated photon pairs from the MRR and guide them in the second direction through the second waveguide and receive the respective second frequency-correlated photon pairs from the MRR and guide them in the first direction through the second waveguide. The PSR is arranged and configured to receive, from the second waveguide, the respective first and second frequency-correlated photon pairs comprising respective signal and idler modes, apply a common polarization rotation to photons of either the respective first or second frequency-correlated photon pairs in a polarization basis comprising mutually orthogonal polarization modes such that the signal and idler within each pair share the same polarization and the polarization mode of the respective first frequency-correlated photon pairs is orthogonal to the respective second frequency-correlated photon pairs, and combine, post-rotation, all pairs to output a first polarization-entangled Bell State.

In an aspect of the disclosure, the nonlinear optical interaction may be spontaneous four-wave mixing.

In an aspect of the disclosure, the PIC may further comprise a second PSR arranged and configured to receive a pump having a first polarization-component and a second polarization-component different from the first polarization-component, split the pump received into first and second optical paths, rotate the polarization of light in the second optical path so that both the first optical path and the second optical path have light with identical polarization and provide, as the first pump and the second pump, outputs of the first optical path and the second optical path to opposite ends of the first waveguide. In other aspects of the disclosure, the PIC may further comprise a splitter selected from a group consisting of a Y-branch splitter and a Mach-Zehnder interferometer (MZI) coupler. The splitter may be arranged and configured to receive a pump and split the pump received into the first pump and the second pump in respective optical paths, preserve the polarization such that the first and second pump have identical polarization, and provide the first pump and the second pump to the first waveguide. The splitter may implement a tunable power-splitting ratio.

In an aspect of the disclosure, the PIC may further comprise a heater embedded in either the first waveguide or the second waveguide and a processor which may be configured to selectively control the heater to impart a preset phase shift to either the respective first or second frequency-correlated photon pairs. Based on the control, the PSR may output either the first polarization-entangled Bell State or a second polarization-entangled Bell State

In an aspect of the disclosure, the PIC may further comprise at least two dual-MRRs which may be disposed inside the second waveguide. Each dual-MRR may have a pair of MRRs between a first portion and a second portion of the second waveguide. Each MRR may be evanescently coupled to the second waveguide. The at least two dual-MRRs may comprise a first dual-MRR and a second dual-MRR. The first dual-MRR may comprise a first MRR and a second MRR. The first and second MRRs may be tuned to a selected frequency corresponding to one mode of a first frequency-correlated photon pair and equal to a corresponding mode frequency of a second frequency-correlated photon pair. The first dual MRR may be configured to (i) couple light at the selected frequency from a first portion of the second waveguide to a second portion via the first and second MRRs, thereby reversing a propagation direction of that mode in the first frequency-correlated photon pair, and (ii) couple light at the same selected frequency from the second portion to the first portion via the second and first MRRs, thereby reversing the propagation direction of that mode in the second frequency-correlated photon pair. Traffic at the selected frequency may be exchanged between the first and second portions. The second dual-MRR may comprise a third MRR and a fourth MRR. The third and fourth MRRs may be tuned to another selected frequency corresponding to one mode of a first frequency-correlated photon pair and equal to a corresponding mode frequency of a second frequency-correlated photon pair. The second dual-MRR may be configured to (i) couple light at the another selected frequency from a first portion of the second waveguide to a second portion via the third and fourth MRRs, thereby reversing a propagation direction of that mode in the first frequency-correlated photon pair, and (ii) couple light at the same another selected frequency from the second portion to the first portion via the fourth and third MRRs, thereby reversing the propagation direction of that mode in the second frequency-correlated photon pair. Traffic at another selected frequency may be exchanged between the first and second portions. The first MRR, the second MRR, the third MRR and the fourth MRR may be respectively tuned using a dedicated heater.

In an aspect of the disclosure, the PSR may receive, after the reversal, the respective first and second frequency-correlated photon pairs with respective signal and idler mode and apply the common polarization rotation to the photons either the respective first or second frequency-correlated photon pairs in a polarization basis comprising mutually orthogonal polarization modes such that for the selected frequency and another selected frequency, the signal and idler mode within each pair have a different polarization mode for both the respective first and second frequency-correlated photon pairs and for other frequencies, the signal and idler mode within each pair share the same polarization mode and the polarization mode of the respective first frequency-correlated photon pairs is orthogonal to the respective second frequency-correlated photon pairs and combine, post-rotation and reversal, all pairs to output both a first polarization-entangled Bell State and a second polarization-entangled Bell State. The second polarization-entangled Bell State comprises the selected frequency and another selected frequency.

In an aspect of the disclosure, the PIC with the dual-MRRs may further comprise a heater embedded in either the first waveguide or the second waveguide and a processor which may be configured to selectively control the heater to impart a preset phase shift to either the respective first or second frequency-correlated photon pairs. Based on the control, the PSR may output one or more polarization-entangled Bell States.

Also disclosed is a quantum transmitter. The quantum transmitter may comprise a PIC in accordance with one or more aspects of the disclosure such as described above. The quantum transmitter may further comprise a pump laser configured to emit a pump at the resonant frequency of the MRR, and a polarization controller disposed between the pump laser and the PIC. The polarization controller may be configured to rotate the polarization of the pump laser and provide the PIC the pump with a target polarization.

In an aspect of the disclosure, the quantum transmitter may further comprise a feedback module and a processor. The feedback module may be configured to monitor the power of light issued from the PIC at a particular frequency. The processor may be configured to maintain a match of the frequency of the pump laser with a resonant frequency of the MRR. For example, the processor may be configured to (1) adjust a frequency of the pump laser based on the power monitored or (2) adjust a resonant frequency of the MRR based on the power monitored. In an aspect of the disclosure, the quantum transmitter may also comprise heater arranged and configured to heat the MRR to adjust the resonant frequency under the control of the processor.

In an aspect of the disclosure, the quantum transmitter may further comprise a first optical filter array arranged between the pump laser and the PIC. The first optical filter array may be configured to filter the pump to have a predefined frequency band centered at the frequency of the pump laser. In an aspect of the disclosure, the quantum transmitter may further comprise a second optical filter array arranged at an output of the PIC. The second optical filter array may be configured to remove the pump from the issued light. In an aspect of the disclosure, the first optical filter array and the second optical filter array may comprise a plurality of Dense Wavelength Division Multiplexing (DWDM) elements.

In an aspect of the disclosure, the quantum transmitter may further comprise a router module. The router module may comprise at least one pulse shaper. The router module may comprise signal mode output ports and idler mode output ports. The router module may be configured to receive the light issued by the PIC, route portions of the issued light having signal mode frequencies f_{S} to the signal mode output ports, and route portions of the issued light having idler mode frequencies f_{I} to the idler mode output ports. In an aspect of the disclosure, a processor may be configured to control the router module to deliver two or more signal mode frequencies f_{S} to a first node and two or more idler mode frequencies f_{I} to a second node which are entangled.

Also disclosed is a network which may comprise a quantum transmitter in accordance with one or more aspects of the disclosure such as described above. The first node and the second node may communicate with each other based on quantum key distribution (QKD) using two or more signal mode frequencies f_{S} and two or more idler mode frequencies f_{I}. Additionally, and/or alternatively, the first node and the second node may perform dense coding using two or more signal mode frequencies f_{S} and two or more idler mode frequencies f_{I}. Additionally, and/or alternatively, the first node and the second node may perform superdense teleportation using two or more signal mode frequencies f_{S} and two or more idler mode frequencies f_{I}. Additionally, and/or alternatively, the first node and the second node may perform entanglement distillation using two or more signal mode frequencies f_{S} and two or more idler mode frequencies f_{I}.

### BRIEF DESCRIPTION OF THE DRAWINGS

FIG. 1 illustrates a block diagram of a quantum transmitter which includes a photonic integrated circuit (PIC) in accordance with aspects of the disclosure;

FIG. 2 illustrates a block diagram of a PIC in accordance with aspects of the disclosure;

FIG. 3A illustrates a diagram of an example of a PIC in accordance with aspects of the disclosure, where in the figure, the direction of light flow and polarizations are shown, the pump propagating within each branch of a first waveguide and correlated photons propagating within each branch of a second waveguide are graphically shown;

FIG. 3B illustrates an example of frequency bin spacing of the photons output by the PIC in accordance with aspects of the disclosure;

FIG. 4A illustrates a block diagram of another PIC in accordance with aspects of the disclosure;

FIG. 4B illustrates a diagram of another example of a PIC in accordance with aspects of the disclosure,

FIG. 5A illustrates a block diagram of another PIC in accordance with aspects of the disclosure;

FIG. 5B illustrates a diagram of another example of a PIC in accordance with aspects of the disclosure,

FIG. 5C illustrates a representation of two frequency entangled pairs in accordance with aspects of the disclosure;

FIG. 6 illustrates a block diagram of an optical filter array in accordance with aspects of the disclosure;

FIG. 7 illustrates a quantum communication system having a quantum transmitter which includes a PIC in accordance with aspects of the disclosure;

FIG. 8 illustrates a block diagram of a network controller in accordance with aspects of the disclosure; and

FIG. 9 illustrates an example of a method of distributing entangled pairs in accordance with aspects of the disclosure.

### DETAILED DESCRIPTION

In accordance with aspects of the disclosure, polarization entangled photons, frequency entangled photons and/or polarization-frequency hyperentangled photons may be distributed from a transmitter having a photonic integrated circuit (PIC) to quantum nodes.

The PIC may be configured and controlled to provide entangled photons (also referred to herein as respective entangled pairs) in one, two and/or all four Bell States in a polarization Degree of Freedom (DOF).

In an aspect of the disclosure, the transmitter with the PIC is capable of providing a broadband spectrum spanning multiple optical communication bands as defined by the International Standards Union (ITU). For example, the transmitter with the PIC may provide conventional band (C-Band) (about 1530 nm-about 1565 nm) and the long band (L-Band) (about 1565 nm-about 1625 nm). Other bands may be used. In some aspects, the transmitter with the PIC is capable of providing over 100 individual pairs of frequency bins.

An example of a quantum node is an optical receiver. Another example of a quantum node is a quantum repeater. The entangled/hyperentangled photons may be used for various different applications. For example, the application(s) may include quantum key distribution (QKD), such as generating quantum-based secret keys for secure communication, dense coding, which allows transmission of two classical bits using a single qubit, entanglement distillation and/or teleportation (superdense teleportation).

The distribution may be in “an on-demand” fashion to pairs of the quantum nodes, such as in the same or a different facility. In a case where the photons are frequency entangled, different frequency encodings may be used, where the number of frequency bins distributed to each node in the Pair of Nodes is the frequency encoding “d”. For example, the frequency encoding may be qubits (d=2) or qutrits (d=3) or a higher dimension (d>3). This effectively creates a flexible grid where more frequency-bins may be allocated when a request for additional service is received.

For purposes of the description a “common polarization rotation” is a unitary transformation applied to both photons of a respective entangled pair. A “polarization basis” means any pair of mutually orthogonal polarization modes, including linear (H/V), circular (R/L), elliptical, and integrated-waveguide eigenmodes (TE/TM). It is noted that several of the figures refer to TE/TM by way of example.

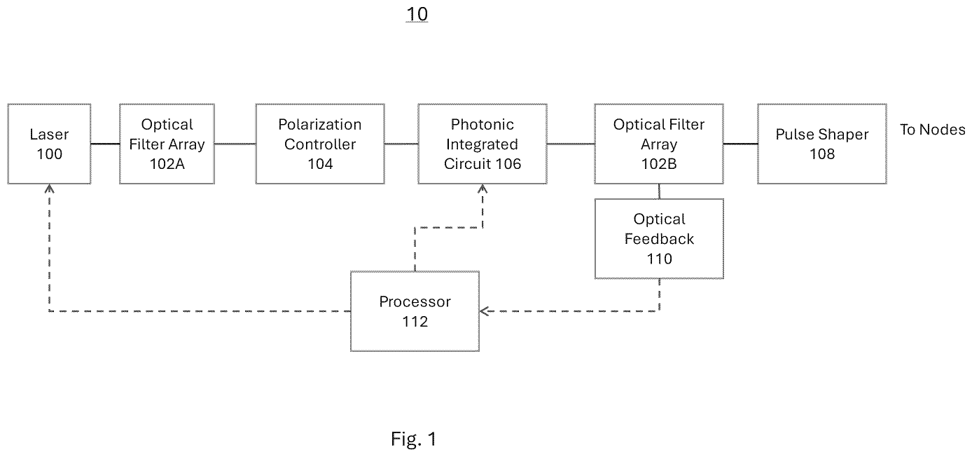

FIG. 1 illustrates a block diagram of a transmitter 10 in accordance with aspects of the disclosure. The transmitter 10 comprises a light source, e.g., laser 100. The laser 100 may be a frequency-stabilized continuous-wave laser. The laser 100 emits light at a target wavelength/frequency. In an aspect of the disclosure, the target wavelength/frequency is a wavelength/frequency which enables entangled pairs of photons to be “centered” with respect to a target multi-band spectrum (equidistant from a desired wavelength/frequency). For example, where the target multi-band spectrum includes the C-Band and the L-Band, the target wavelength/frequency may enable the centering to be at the border between the two bands. For example, the target wavelength may be about 1560 nm (central wavelength), such as, but not limited to 1559.85 nm. For example, the laser 100 may be model number Santec TSL-570, which is a tunable laser. For instance, the laser 100 may be tuned from 1240 nm to 1680 nm. The light may have a power of less than 10 mW. In other aspects, the power may be less than 20 mW. The wavelength of the laser 100 may be controlled by a processor 112.

The light from the laser 100 may be amplified, as needed (amplifier not shown). The light is used as a “pump”. In other aspects, a shorter-wavelength pump laser may be used, such as when spontaneous parametric down-conversion (SPDC) is used instead of spontaneous four wave mixing (SFWM).

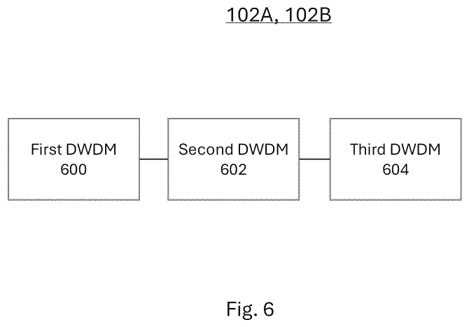

While the pump may have a center wavelength of about 1560 nm, there may be some background noise. To attenuate the background noise from the pump, the transmitter 10 may include an optical filter array 102A. In an aspect of the disclosure, the optical filter array 102A may comprise one or more dense wavelength division multiplexers (DWDMs). For example, there may be three DWDMs (first DWDM 600, second DWDM 602 and third DWDM 604) (see FIG. 6). However, the number of DWDMs is not limited to three and more or less may be used. However, the more DWDMs used, the lower the power level will be into the PIC 106 (but with less background noise). A lower number of DWDMs, increases the power level into the PIC 106 (but with more background noise). Each DWDM has a fixed passband. In some aspects, the passband may be different. For example, the first DWDM 600 may have a 100 GHz passband. The second DWDM 602 may also have a 100 GHz passband. The third DWDM 604 may have a 50 GHz passband. These are examples for descriptive purposes and other bandpass(es) may be used. In some aspects, the passband may be based on the frequency bin spacing. The removal of the background noise minimizes the overlap of the pump with any frequency bin output by the transmitter 10. When the frequency bin spacing is closer together, the passband may be smaller. For example, when the frequency bin spacing is closer, the DWDM may have a 25 GHz passband or a 30 GHz passband. The through (pass) port of the DWDM is connected to the subsequent DWDM. The drop-port may be directed to a light dump. The laser 100 may be connected to the first DWDM 600 via a single mode fiber.

In an aspect of the disclosure, each DWDM 600, 602, 604 may have the passband centered about 1560 nm, such as 1559.81 nm.

The transmitter 10 also comprises a polarization controller 104. The polarization controller 104 may be an inline fiber polarization controller, such as a fiber squeezer. In other aspects of the disclosure, the polarization controller 104 may be motorized waveplates or a liquid crystal waveplate (liquid crystal variable retarder and quarter-wave plate) enables a continuous adjustment of a polarization of an input beam (pump). The liquid crystal variable retarder or motorized waveplates may be driven via a processor 112. The polarization controller 104 manages the ratio of the polarization modes into the PIC 106 (ratio of a first polarization mode to a second polarization mode). The polarization controller 104 may be connected to the last DWDM (e.g., 604) also via a single mode fiber.

The polarization controller 104 may be coupled to the PIC 106 via a single mode fiber with a micro-lens on the end (“lensed fiber”). The lens focuses the pump beam to a small spot at the input facet of the PIC, thereby free-space coupling the pump into a waveguide.

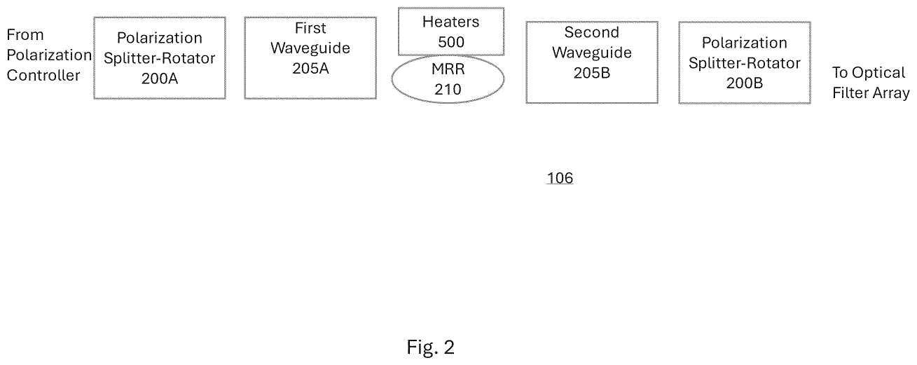

FIG. 2 illustrates a block diagram of a PIC 106 in accordance with aspects of the disclosure. The PIC 106 comprises a polarization-splitter rotator (PSR) 200A, a first waveguide 205A, a microring resonator (MRR) 210, a second waveguide 205B, and PSR 200B.

The PIC 106 may be fabricated using a complementary metal-oxide semiconductor (CMOS)-compatible processes on a silicon (Si) substrate, which defines the waveguides of the PIC 106. However, other photonic platforms may be used, including Si₃N₄, LiNbO₃, and AlGaAs.

The PSR 200A may comprise of multiple waveguides. The waveguides are designed/configured to operate with the target wavelength (of the laser 100). The PSR 200A spatially separates the first polarization mode and the second polarization mode and rotates one of the polarization modes. For example, a first PSR waveguide may be evanescently coupled to a second PSR waveguide, such that one of the polarization modes may be coupled from the first PSR waveguide to the second PSR waveguide, and its polarization may be rotated within the second PSR waveguide.

The two waveguides (first PSR waveguide and the second PSR waveguide) of the PSR 200A are directly connected to opposite ends of waveguide 205A. Within PSR 200A, the two orthogonal polarization modes are spatially separated, and one mode is rotated so that both outputs present the same polarization state. As a result, pump light of identical polarization enters the waveguide 205A from opposite directions along two paths. For clarity, the two PSR outputs are referred to as the first pump and the second pump.

In an aspect of the disclosure, the PSR 200A may be replaced with a beam splitter such as a Y-branch connection. In some aspects, the Y-branch connection may be a planar lightwave circuit (PLC) splitter which is fabricated on the substrate such as silicon. The beam splitter may separate the pump into a set ratio. In some aspects, the ratio may be a 50:50 split. However, in other aspects, a different ratio may be used. The two output waveguides of the beam splitter may also be directly connected to opposite ends of the first waveguide 205A.

In other aspects, the beam splitter may be a tunable or variable beam splitter. The tunable beam splitter may be actively controlled to adjust the ratio. This is because there may be need to adjust the power of the first pump and the second pump within the first waveguide 205A to counteract any imbalances in loss or efficiency. In an aspect of the disclosure, the tunable beam splitter may be a Mach-Zehnder interferometer (MZI).

The first waveguide 205A is arranged such that each pump (first and second pump) is able to propagate within the first waveguide 205A in different directions. The different directions may be referred to herein as “a clockwise direction” and “a counterclockwise direction”. The first waveguide 205A may also be referred to herein as an input waveguide. The first waveguide 205A may have a generally open loop shape.

The first waveguide 205A includes a coupling section that is brought into close proximity to a coupling section of the MRR 210 to form an evanescent directional-coupling region. The first pump and second pump are bidirectionally coupled into the MRR 210, meaning that one of the first pump or the second pump propagates in one direction within the MRR and the other of the first pump or the second pump propagates in the other direction. For example, if first pump is propagating within the first waveguide 205A in a clockwise direction, it will propagate within the MRR 210 in a counterclockwise direction.

The MRR 210 has a free spectral range (FSR). The FSR is the frequency or wavelength spacing between adjacent interference maxima (or minima) in an interferometer or optical resonator. The FSR is based on the refractive index n and the cavity length. The longer the cavity length, the closer the spacing between the adjacent interference maxima (or minima), e.g., available resonance. The FSR may determine the frequency-bin spacing. In some aspects of the disclosure, the bin spacing may be 25 GHz. However, the bin spacing is not limited to this spacing. In some aspects of the disclosure, the spacing may be consistent with the ITU grid.

The MRR 210/laser 100 are configured to have a wavelength/frequency of resonance of the MRR 210 match the center wavelength/frequency of the laser 100. As noted above, the laser 100 may have a center wavelength of about 1560 nm. Therefore, in accordance with aspects of the disclosure, the MRR 210 may be configured to have a resonance at about 1560 nm.

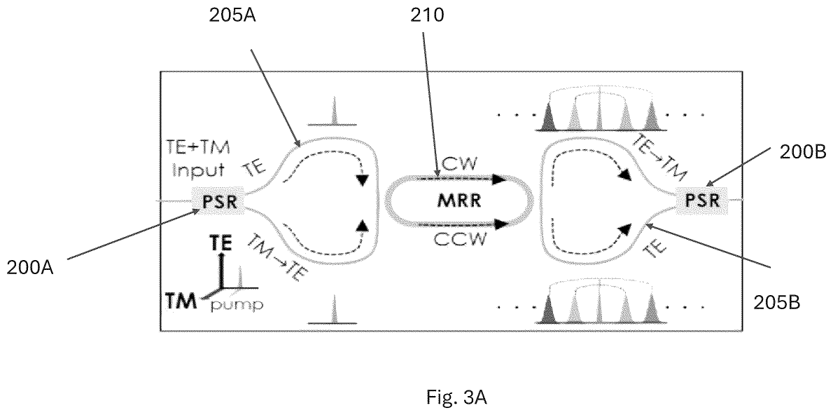

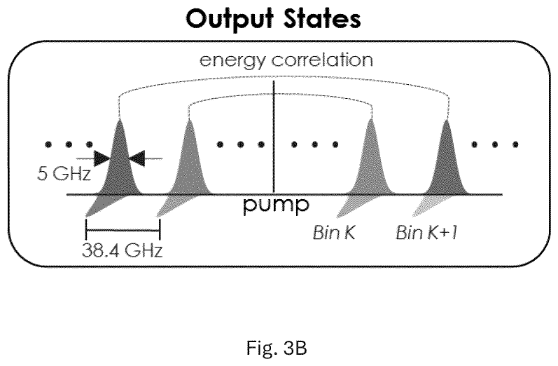

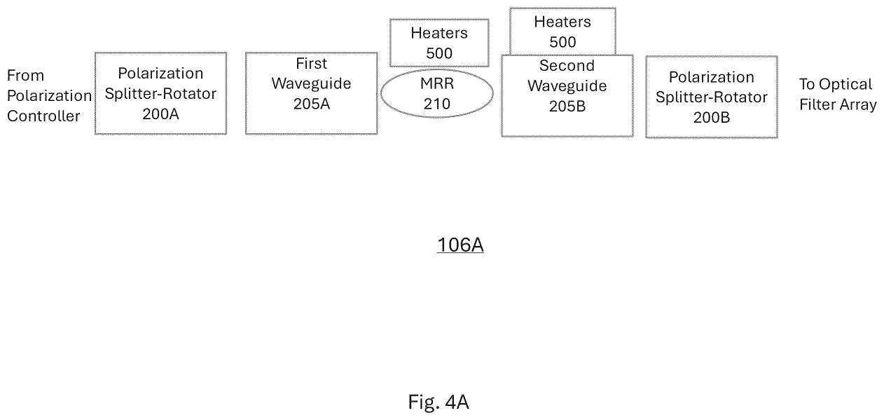

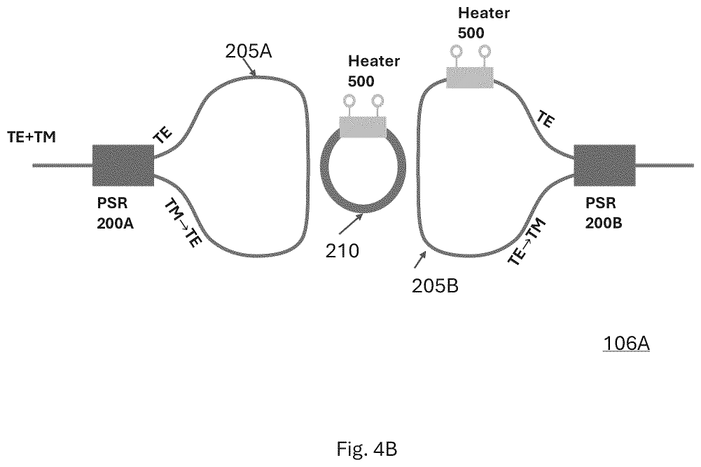

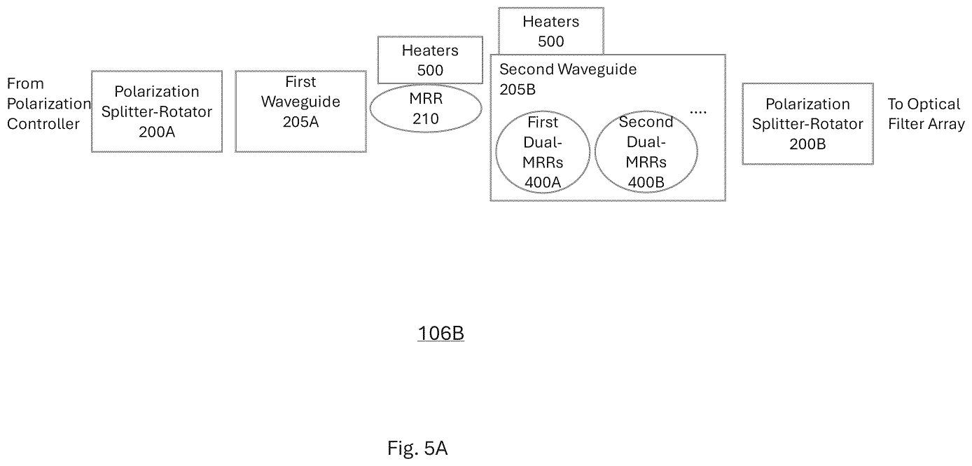

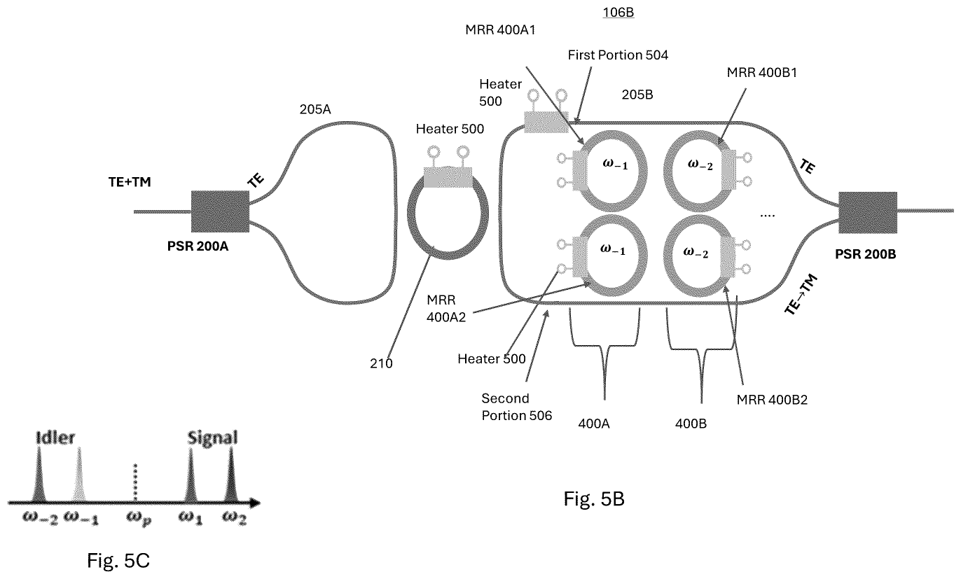

The MRR 210 has a closed loop configuration. In some aspects of the disclosure, the MRR 210 may be circular such as shown in the example in FIG. 4B and FIG. 5B. In other aspects of the disclosure, the MRR 210 may be oval. In other aspects of the disclosure, the MRR 210 may have a racetrack configuration such as shown in the example in FIG. 3A. The MRR 210 may also have adiabatic curves.

There is a gap (G1) between the first waveguide 205A and the MRR 210. The gap (G1) impacts the coupling condition for the MRR 210. The gap (G1) may be set to enable efficient evanescent coupling of the first pump and the second pump into the MRR 210. However, the gap (G1) is set not to close to allow the signal and idler mode pair(s) generated within the MRR 210 to be evanescently coupled back into the first waveguide 205A. Additionally, the quality factor (Q-factor) of MRR 210—which determines its resonance linewidth—is set by intrinsic scattering and propagation attenuation within the MRR 210, together with the external coupling to the bus waveguides 205A and 205B. In the example illustrated in FIG. 3A (as shown in FIG. 3B), the linewidth is 5 GHz.

The resonance wavelengths of MRR 210 vary with temperature due to the thermo-optic effect and thermal expansion, which changes the effective refractive index and the optical path length. Consequently, as transmitter 10 operates and the MRR's temperature drifts, the ring resonances shift and can become misaligned with the laser 100 center wavelength/frequency. The FSR also depends on the refractive index and circumference and may change slightly with temperature, further contributing to resonance drift.

In some aspects of the disclosure, the MRR 210 may have one or more embedded microheaters 500. The microheaters 500 may be equally spaced within the MRR 210. The microheaters 500 may be resistive. The microheaters 500 may be controlled to tune the resonance (e.g., maintain the match). In other aspects, to maintain the match, the center wavelength/frequency of the laser 100 may be tuned.

In an aspect of the disclosure, the MRR 210 may be configured to support different nonlinear optical interactions. The material of the MRR 210 may impact which nonlinear optical interaction the MRR supports. For example, in some aspects of the disclosure, the MRR 210 may be configured for spontaneous four-wave mixing (SFWM) and the material may include higher-nonlinearity, low-loss materials such as silicon, silicon nitride, Hydex, AlGaAs, aluminum nitride, and GaP. For example, a single photon, e.g., pump, converts into signal and idler photons (also referred to herein as signal mode or signal and idler mode or idler. The signal and idler photons within the MRR 210 may have the same polarization as the original pump photons, and the photon pairs exhibit frequency entanglement. Thus, since there are bidirectionally flowing pumps (first pump and second pump), photons in the first pump can convert to respective first signal and idler photons and photons in the second pump can convert to respective second signal and idler photons. The respective first signal and idler photons may also be referred to herein as respective first entangled pairs and the respective second signal and idler photons may be referred to as respective second entangled pairs. In other aspects of the disclosure, the MRR 210 may be configured for other non-linear optical interactions such as spontaneous parametric down-conversion (SPDC). The MRR 210 may be formed from a noncentrosymmetric medium and with a tighter phase-matching such as, but not limited to, lithium niobate. Depending on the nonlinear optical interaction and laser 100 waveguide different single mode fibers between the laser 100 and the PIC 106, 106A, 106B may be used.

The second waveguide 205B is arranged to evanescently couple to the MRR 210 in the same manner as the first waveguide 205A. The second waveguide 205B may have a corresponding shape as the first waveguide 205A (such as a mirror image). The second waveguide 205B may also be referred to as an output waveguide. There may be a similar gap between the second waveguide 205B and the MRR 210 (G2), such that G2=G1. The second waveguide 205B extracts/acquires the respective first entangled pairs and the respective second entangled pairs from the MRR 210. If the respective first entangled pairs are propagating in a clockwise direction within the MRR 210, the first entangled pairs will propagate in a counterclockwise direction within the second waveguide 205B or vice versa.

The second PSR 200B may mirror the first PSR 200A. Similar to the first PSR 200A, the second PSR 200B may include multiple internal waveguides. One of the second PSRs waveguides may rotate, in the polarization basis, either the respective first entangled pairs or the respective second entangled pairs. Once rotated, one of the second PSR's waveguides evanescently couples its respective entangled pairs to another PSR waveguide, which combines entangled pairs (first and second entangles pairs) to issue the biphoton entangled pairs. The two output waveguides of PSR 200B are directly connected to opposite ends of waveguide 205B. In this aspect of the disclosure, the output is an equal coherent superposition of the two counterpropagating respective entangled pairs, which may manifest a polarization Bell State of

$$\vert {Φ}^{+} 〉 = \frac{1}{\sqrt{2}} \vert HH 〉 + \frac{1}{\sqrt{2}} \vert VV 〉 ,$$

where the first polarization mode is represented as horizontal polarization (“H”) and the second polarization mode is represented as vertical polarization (“V”).

FIG. 3A illustrates an example of a PIC 106 in accordance with aspects of the disclosure. In FIG. 3A, the first polarization mode is TE and the second polarization mode is TM. The pump input to the PIC 106 is represented as TE+TM input showing both polarization modes. There is a legend also illustrating the pump having both polarization modes. In the legend, the linewidth of the pump is shown. Of note, this linewidth is the filtered linewidth of the pump.

It is noted that the PSR 200A is illustrated over the first waveguide 205A, however, as noted above, the PSR 200A has multiple PSR waveguides and its two waveguides (first PSR waveguide and second PSR waveguide) are connected to opposite ends of the first waveguide 205A. The position of the PSR 200A with respect to the first waveguide 205A is intended to show the split and rotation of the pump. The rotation is represented by TM->TE. The dotted arrows within the first waveguide 205A illustrate the direction of propagate, e.g., clockwise and counterclockwise. The first pump and second pump within the first waveguide 205A is represented in a legend above and below the first waveguide 205A.

The first pump and the second pump bidirectional couple into the MRR 210 in opposite directions through a coupling section between waveguide 205A and the MRR 210. In the MRR 210, the direction of propagation is noted as CW (for clockwise) and CCW (for counterclockwise). In this example, the MRR 210 is 500 nm wide by 220 nm thick and FSR is 38.4 GHz. These are non-limiting examples. MRR 210 has a racetrack shape.

Representations of the respective first entangled pairs and the respective second entangled pairs are illustrated below and above the second waveguide 205B. Two respective entangled pairs are shown with “ . . . ” indicating other pairs. The curves connecting the resonances identify the frequency correlated pairs. The dotted arrows within the second waveguide 205B illustrate the direction of propagation, e.g., clockwise and counterclockwise,

Similarly, it is noted that the PSR 200B is illustrated over the second waveguide 205B, however, as noted above, the PSR 200B has multiple PSR waveguides and its two output waveguides are connected to opposite ends of the second waveguide 205B. The position of the PSR 200B with respect to the second waveguide 205B is intended to show the rotation of one of the respective first entangled pairs or respective second entangled pairs followed by the combination. The rotation is represented by TE->TM.

In some aspects, the width and height of the waveguides 205A, 205B are set to support single mode operation.

FIG. 3B illustrates an example of the entangled pairs output from the PIC 106. The pump frequency/wavelength is illustrated in the center (vertical line). The frequency-bin spacing as defined by the FSR is also illustrated (e.g., 38.4 GHz) and the linewidth (e.g., 5 GHz). Once again, two entangled pairs are shown in the figure. The “ . . . ” represents the other entangled bin pairs.

FIG. 4A illustrates a block diagram of another PIC 106A in accordance with aspects of the disclosure. The difference between the PIC 106A and PIC 106 in FIG. 2 (and FIG. 3A) is that in PIC 106A there are additional microheaters 500 embedded in the second waveguide 205B and positioned in one of the paths. The PIC 106 is configured to provide one of the four polarization Bell States. The PIC 106A is capable of providing two of the four polarization Bell States, e.g., changing |Φ⁺ [symbol] to |Φ⁻ [symbol] . Since the refractive index of the second waveguide 205B is temperature sensitive, heating/cooling the second waveguide 205B can controllably change the refractive index. By changing the refractive index of the second waveguide 205B, a phase shift can be imparted. By causing a preset phase shift, such as π/2, the polarization Bell State can change from

$$\vert {Φ}^{+} 〉 = \frac{1}{\sqrt{2}} \vert HH 〉 + \frac{1}{\sqrt{2}} \vert VV 〉 to \vert {Φ}^{-} 〉 = \frac{1}{\sqrt{2}} \vert HH 〉 - \frac{1}{\sqrt{2}} \vert VV 〉 .$$

In an aspect of the disclosure, the amount of heating/cooling required to impart the preset phase shift may be determined via a calibration process. Calibration is performed by sweeping the heater current and locating the π-phase point—using an interference fringe with a classical probe, or polarization quantum state tomography with photon pairs. The corresponding drive setting is stored as a setpoint and used thereafter to select Φ⁺ or Φ⁻.

In other aspects, the heater(s) 500 may be embedded in the first waveguide 205A and positioned in one of the paths instead of the second waveguide 205B. In other aspects, the heater(s) 500 may be embedded in both the first waveguide 205A and the second waveguide 205B.

FIG. 4B illustrates an example of the PIC 106A in accordance with aspects of the disclosure having the heater(s) 500, which may be selectively controlled to impart the preset phase shift. It is noted that the amount of heating/cooling may change over time as the ambient temperature or the operating temperature of the second waveguide 205B (and/or first waveguide 205A) changes over time. In FIG. 4B, the heater(s) 500 are shown as being superimposed over the respective element (MRR 210) or second waveguide 205B for illustrative purposes only.

FIG. 5A illustrates a block diagram of another PIC 106B in accordance with aspects of the disclosure. The PIC 106B illustrated in FIG. 5A is capable of producing all four polarization Bell States

$$\vert {Φ}^{+} 〉 = \frac{1}{\sqrt{2}} \vert HH 〉 + \frac{1}{\sqrt{2}} \vert VV 〉 , \vert {Φ}^{-} 〉 = \frac{1}{\sqrt{2}} \vert HH 〉 - \frac{1}{\sqrt{2}} \vert VV 〉 , \vert {Ψ}^{+} 〉 = \frac{1}{\sqrt{2}} \vert HV 〉 + \frac{1}{\sqrt{2}} \vert VH 〉 , \vert {Ψ}^{-} 〉 = \frac{1}{\sqrt{2}} \vert HV 〉 - \frac{1}{\sqrt{2}} \vert VH 〉 .$$

The PIC 106B further has a plurality of dual-MRRs 400A, 400B, . . . . Each of the dual-MRRs (e.g., 400A, 400B) act as a wavelength-selective add-drop filter. Each dual-MRRs (e.g., 400A, 400B) is positioned between different portions (first portion 504 and second portion 506) of the second waveguide 205B. Specifically, each dual-MRRs (e.g., 400A, 400B) is positioned between the path where the respective first entangled pairs and the respective second entangled pairs are propagating. The dual-MRRs 400A, 400B are formed on a co-planar substrate.

The MRRs, within a dual-MRRs (e.g., 400A, 400B) are tuned to the same wavelength/frequency. In one aspect of the disclosure, this may be achieved by setting the circumference of the MRRs to target a certain FSR. The FSR is inversely proportional to the circumference. Each MRR, which acts as a wavelength/frequency filter is smaller in circumference than the MRR 210. Thus, the spacing between individual MRR resonances is larger. The length may be set such that the MRRs within a specific dual-MRR (e.g., 400A) only overlaps with one frequency bin. In an aspect of the disclosure, the MRRs in different dual-MRRs may have a different length such that the MRRs are tuned to a different wavelength/frequency. In other aspects, the MRRs in the different dual-MRRs may have the same length, but have their resonance locations tuned to different wavelengths/frequencies via the heaters 500.

Each MRR is positioned to evanescently couple to a portion of the second waveguide 205B. MRRs within the same dual-MRRs (e.g., 400A) are positioned with respect to each other to evanescently couple.

In an aspect of the disclosure, a signal or idler photon propagating along a first portion 504 of the second waveguide 205B, which matches the wavelength/frequency of one of the dual-MRR filter(s), is evanescently coupled into the MRRs, exchanged between the two rings via their inter-ring coupling region, and then coupled out to a second portion 506 of the second waveguide 205B to continue along the second portion 506. Similarly, a signal or idler photon propagating along a second portion 506 of the second waveguide 205B which matches the wavelength/frequency of one of the dual-MRR filter(s), will be transferred to the first portion 504 of the second waveguide 205B via the dual-MRRs (e.g., 400A).

Additionally, each MRR within a dual-MRRs (e.g., 400A, 400B) has a heater 500 embedded therein. The heater 500 may be controlled to maintain the resonance at a target setting.

The PIC 106B may also have the heater(s) 500 embedded in the second waveguide 205B to impart the preset phase shift as described above.

FIG. 5B illustrates an example of the PIC 106B in accordance with aspects of the disclosure having paths for switching either the signal or idler photons of entangled pairs in accordance with aspects of the disclosure. In the example illustrated in FIG. 5B, two dual-MIRRs 400A, 400B are explicitly shown. Additional dual-MRRs are indicated by “ . . . ”. In the example, the switching is for the idler photons in the entangled pairs. For example, for a qubit frequency encoding (d=2), two energy-matched entangled pairs include (ω₁, ω₋₁) and (ω₂, _{ω-2}) such as shown in FIG. 5C. The first dual-MRRs 400A are tuned to ω₋₁ and the second dual-MRRs 400B are tuned to ω₋₂. In the example, the first portion 504 of the second waveguide 205B is on top and the second portion 506 of the second waveguide 205B is on bottom.

For example, an idler photon having a wavelength/frequency ω₋₁ of a respective entangled pair propagating in a clockwise direction through the first portion 504 (input bus waveguide) will evanescently couple the optical power to MRR 400A1 at a first coupling section and the MRR 400A1 is configured to evanescently couple optical power into a MRR 400A2 at a second, spatially separated coupling section located at a different position along the ring circumference. Together, the separation between the coupling sections, along with the coupling gaps and overlap lengths, determine the external and inter-ring coupling coefficients. During operation at resonance, optical energy builds in the MRR 400A1 and is transferred to the MRR 400A2 via the inter-ring coupling section, from which the energy is routed to the second portion 506 (output waveguide or drop port), thereby effecting controlled energy transfer from a first portion 504 to the second portion 506. The transfer reverses the direction of propagation of the photon, e.g., idler photon.

Similarly, an idler photon, for example, having the same wavelength/frequency ω₋₁ of a respective entangled pair (corresponding pair) propagating in a counterclockwise direction through the second portion 506 (input bus waveguide) will evanescently couple the optical power to MRR 400A2 at a coupling section and the MRR 400A2 is configured to evanescently couple optical power into a MRR 400A1 at a spatially separated coupling section located at a different position along the ring circumference. During operation at resonance, optical energy builds in the MRR 400A2 and is transferred to the MRR 400A1 via the inter-ring coupling section, from which the energy is routed to the first portion 504 (output waveguide or drop port), thereby effecting controlled energy transfer from a second portion 506 to the first portion 504. The transfer reverses the direction of propagation of the photon, e.g., idler photon.

Additionally, in FIG. 5B, an idler photon having a wavelength/frequency ω₋₂ follows a similar path to switch between the first portion 504 and the second portion 506 and vice versa. For example, an idler photon having a wavelength/frequency ω₋₂ of a respective entangled pair propagating in a clockwise direction through the first portion 504 (input bus waveguide) will evanescently couple the optical power to MRR 400B1 at a first coupling section and the MRR 400B1 is configured to evanescently couple optical power into a MRR 400B2 at a second, spatially separated coupling section located at a different position along the ring circumference. Together, the separation between the coupling sections, along with the coupling gaps and overlap lengths, determine the external and inter-ring coupling coefficients. During operation at resonance, optical energy builds in the MRR 400B1 and is transferred to the MRR 400B2 via the inter-ring coupling section, from which the energy is routed to the second portion 506 (output waveguide or drop port), thereby effecting controlled energy transfer (idler photon having a wavelength/frequency ω₋₂) from a first portion 504 to the second portion 506. The transfer reverses the direction of propagation of the photon, e.g., idler photon.

Similarly, an idler photon, for example, having the same wavelength/frequency ω₋₂ of a respective entangled pair (corresponding pair) propagating in a counterclockwise direction through the second portion 506 (input bus waveguide) will evanescently couple the optical power to MRR 400B2 at a coupling section and the MRR 400B2 is configured to evanescently couple optical power into a MRR 400B1 at a spatially separated coupling section located at a different position along the ring circumference. During operation at resonance, optical energy builds in the MRR 400B2 and is transferred to the MRR 400B1 via the inter-ring coupling section, from which the energy is routed to the first portion 504 (output waveguide or drop port), thereby effecting controlled energy transfer (idler photon having a wavelength/frequency ω₋₂) from a second portion 506 to the first portion 504. The transfer reverses the direction of propagation of the photon, e.g., idler photon.

Photons other than matching the wavelength/frequency of the dual-MRRs (e.g., ω₋₂ or ω₋₁) will continue along their respective paths, e.g., the first portion 504 or the second portion 506 and not be transferred. Since only one of the portions (either the first portion 504 or the second portion 506) has entangled photons rotated (and in the example shown in FIG. 5B, its the second portion 506), the switching of the portions that the photons propagating to the PSR 200B changes the polarization. This in combination with a heater 500 embedded in the second waveguide 205B enables the PIC 106B to provide the additional Bell States |Ψ_{±} [symbol] =|HV [symbol] ±|VH [symbol] .

The heaters embedded within each filter MRR (e.g., 400A1, 400A2, 400B1, 400B2) may be selectively controlled to tune or detune the resonance of each filter MRR (e.g., 400A1, 400A2, 400B1, 400B2) to a specific wavelength/frequency. When each filter MRR (e.g., 400A1, 400A2, 400B1, 400B2) are detuned away from all of the frequency bins, the polarization states correspond to

$$\vert {Φ}^{\pm } 〉 = \frac{1}{\sqrt{2}} \vert HH 〉 \pm \frac{1}{\sqrt{2}} \vert VV 〉 .$$

The PIC 106B may be selectively controlled to produce different polarization Bell states determined by heater settings for each filter MRR (e.g., 400A1, 400A2, 400B1, 400B2) and the second waveguide 205B. The generated hyperentangled states may be expressed as

$$\begin{matrix}1 / 2 ( \vert ω\_ 1 , ω\_ ( - 1 ) 〉 + \vert ω\_ 2 , ω\_ ( - 2 ) 〉 ) ⊗ ( \vert HH 〉 \pm \vert VV 〉 ) \\ 1 / 2 ( \vert ω\_ 1 , ω\_ ( - 1 ) 〉 + \vert ω\_ 2 , ω\_ ( - 2 ) 〉 ) ⊗ ( \vert HV 〉 \pm \vert VH 〉 ) ,\end{matrix}$$

where the first term represents frequency DOF and the second term the polarization DOF.

The heaters 500 for each filter MRR (e.g., 400A1, 400A2, 400B1, 400B2) may be controlled by the processor 112. The heater(s) 500 embedded in the second waveguide 205B may also be controlled by the processor 112.

The output of the PIC 106, 106A, 106B (off chip) may be optically coupled to an optical filter array 102B. The optical filter array 102B may be connected to the PIC 106, 106A, 106B via a single mode fiber (micro-lensed fiber). Similar to the optical filter array 102A, the optical filter array 102B may comprise a plurality of DWDMs. The optical filter array 102B is configured to remove any residual pump from the respective entangled pairs (broadband). There may be three DWDMs (first DWDM 600, second DWDM 602 and third DWDM 604) (see FIG. 6). However, the number of DWDMs is not limited to three and more or less may be used. However, the more DWDMs used, the lower the power level of the respective entangled pairs, especially near the wavelength/frequency of the pump.

Each DWDM has a fixed passband. In some aspects, the passband may be different. For example, the first DWDM 600 may have a 100 GHz passband. The second DWDM 602 may also have a 100 GHz passband. The third DWDM 604 may have a 50 GHz passband. These are examples for descriptive purposes and other passband(s) may be used. In some aspects, the choice of bandpass filters may be based on the frequency bin spacing. The removal of the residual pump minimizes the overlap of the residual pump with any frequency bin output by the transmitter 10. When the frequency bin spacing is closer, the bandpass may be smaller. For example, when the frequency bind spacing is closer, the DWDM may have a 25 GHz bandpass or a 30 GHz bandpass.

In the optical filter array 102B, the connections between the different DWDM are the opposite of the connections in the optical filter array 102A, the through (pass) port may be connected to a “dump” and the drop-port connected to a subsequent DWDM.

In an aspect of the disclosure, the optical filter array 102B may suppress the pump by about 68 dB with a loss of about 3 dB in the respective entangled pairs.

In an aspect of the disclosure, the through (pass) port of first DWDM 600 in the optical filter array 102B may be used as a feedback (“tap”), e.g., optical feedback 110. For example, a power meter may be connected to the through (pass) port. The power meter is configured to detect the power level of its input (the residual pump). Any known optical power meter may be used. The power meter is connected to the processor 112. A change in the measured power level is indicative of the resonance of the MRR 210 changing, e.g., no longer matching the wavelength/frequency of the laser 100.

In an aspect of the disclosure, the processor 112 continuously monitors the output of the power meter to detect a change. When the power level changes by more than a threshold, either the wavelength/frequency of the laser 100 is changed or the temperature of the MRR 210 is changed. To determine in what direction the change needs to be made, the processor 112 may control the wavelength of the laser 100 to be (1) below a current wavelength and detect the power level and (2) above the current wavelength and detect the power level. The processor 112 may then compare the two detected power levels and a sign of the change determines whether the tuning is to increase the wavelength or decrease the wavelength. Alternately, the processor 112 may control the heater(s) 500 embedded in the MRR 210 to be (1) below a current heating setting and detect the power level and (2) above the current heating setting and detect the power level. The processor 112 may then compare the two detected power levels and a sign of the change determines whether the tuning is to increase the setting or decrease the setting. This is to counteract the cavity resonance drift in the presence of real-time thermal drift.

The optical filter array 102B is optically coupled to a pulse shaper 108. In some aspects of the disclosure, the pulse shaper 108 may be a Fourier transformer pulse shaper. The pulse shaper 108 functions as a reconfigurable wavelength demultiplexer, programmably directing spectral components corresponding to the MRR 210's resonance-defined frequency bins to designated output fiber ports.

The pulse shaper 108 has at least one pair of output ports (and preferably multiple pairs) and one input port. In some aspects, the pulse shaper 108 may be a C+L pulse shaper. In this case, one of the ports in the pair may be a C-band port (for the signal mode of a respective entangled pair) and the other port in the pair may be a L-band port (for the idler mode of the respective entangled pair). The pulse shaper 108 can send one or more frequency bins (multiplexing) to a port (under the control of a processor 800 of the network controller 700). A node (e.g., Node 1 20A) is optically connected to an output port of pulse shaper 108 (e.g., C-band port) and another node (e.g., Node 2 20B) is optically connected to another output port of pulse shaper 108 (e.g., L-band port). In a case where there are multiple parts of output ports, additional nodes may be connected in pair to these ports as well.

Additionally, the pulse shaper 108 may apply a phase shift to the different frequency bins (also under the control of the processor 800 of the network controller 700).

The use of a phase shift may be selectively applied based on an application and algorithm used for quantum state tomography (QST). For example, for a certain QST, a random phase may be added to each frequency bin.

A pulse shaper 108, such as Finisar Waveshaper 4000B may be used.

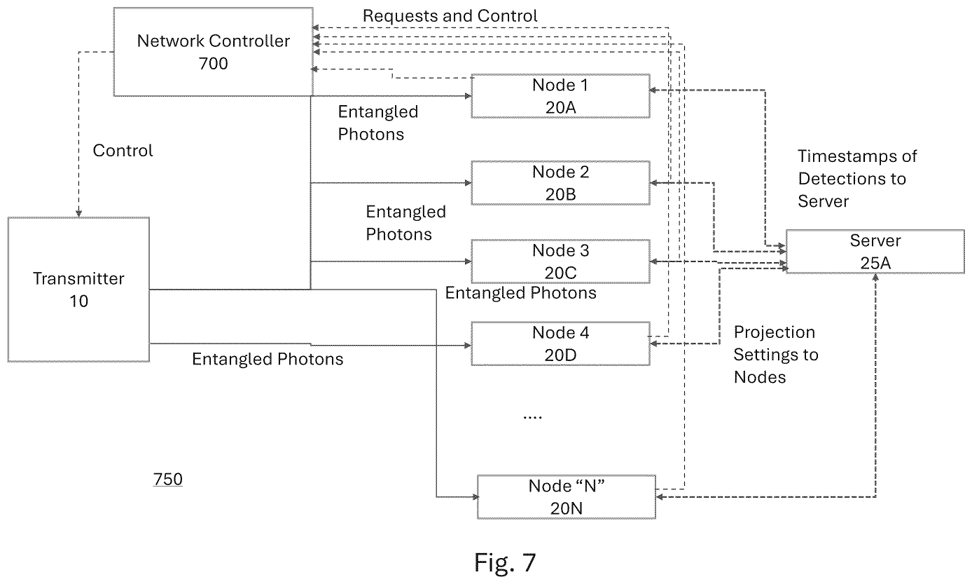

In an aspect of the disclosure, a transmitter 10 may be incorporated into a communications system 750, an example of which is illustrated in FIG. 7. The communications system 7 may comprise a transmitter 10 as described herein, nodes 20A-20N, a server 25A, and a network controller 700.

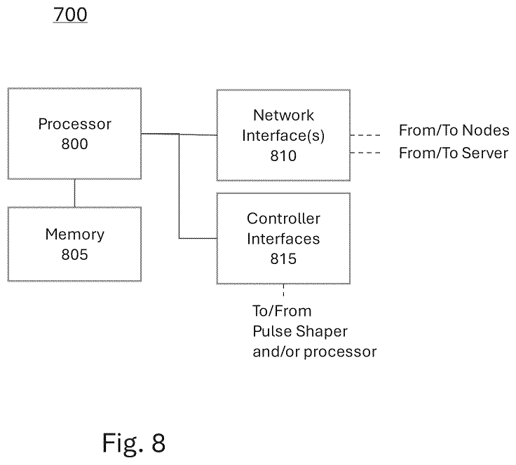

FIG. 8 illustrates a block diagram of a network controller 700 in accordance with aspects of the disclosure. The network controller 700 may comprise the processor 800, memory 805, network interface(s) 810 and controller interface 815. The processor 800 may be a CPU. In other aspects, the processor 800 may be a microcontroller or microprocessor or any other processing hardware such as a field programmable gate array (FPGA). The processor 800 may be configured to execute one or more programs stored in a memory (such as memory 805) to execute the functionality described herein. In some aspects of the disclosure, where the network controller 700 is incorporated in the transmitter 10, the processor 800 and the processor 112 may be the same.

In accordance with aspects of the disclosure, the memory 805 may store management information. The management information includes frequency bin definitions (e.g., a channel list). Additionally, the management information may include a mapping associated with respective entangled pairs (signal mode and idler mode relationship). In some aspects, this mapping may be stored as a table (“Entanglement Table”).

This mapping enables the processor 800 to identify the corresponding bins and simultaneously control the same, via the pulse shaper 108, to be multiplex and/or demultiplexed, as needed, to fulfill a request.

The management information may also include output port status information. The status may include connected (not available) or available (open). The “open” or “available” status means that no node is “connected” to a given port. The node “connected”, or “not available” status means that a node is “connected”. “Connected” used herein is separate from active traffic transmission. For example, a node (e.g., Node 1 20A) may be “physically connected” to the output port, but no network traffic is being transmitted. The node (e.g., Node 1 20A) may also be connected to an output port via free space as opposed to fiber-based.

The status information may also include allocation status, e.g., whether frequency bins are being sent to a Node Pair. The status information may be stored as a table (“Status Table”). In some aspects of the disclosure, the allocation status may also include a unique identifier of the node (e.g., Node 1 20A) connected to the output port. The unique identifier may be a network address such as an Internet protocol (IP) address, a medium access control (MAC) address or another identifier identifying the Node (e.g., Node 1 20A).

In an aspect of the disclosure, the frequency encoding (d) may be predefined during a configuration stage. In other aspects of the disclosure, the frequency encoding (d) may be included in a request for the distribution of respective entangled pairs such as a request for a service. For example, the request may be received from either the server 25A or one of the nodes. The request may change over time such as when additional service is needed. Thus, the communication system has a flexible grid. For example, the request associated with a specific Node Pair may initially be for qubit frequency encoding (d=2), however, a subsequent request may be for a qutrit frequency encoding (d=3) (additional bandwidth). In other aspects, the entanglement may only be a polarization entanglement.

The network interface(s) 810 may be wired or wireless interface(s). The wireless interfaces may be a Wi-Fi® interface. Additionally, depending on the location of any node, the wireless interface may be a near-field communication interface. The network controller 700 is able to receive requests for respective entangled pairs via the network interface(s) 810 (from the server 25A or from one of the nodes). The network interface(s) 810 may be different for different nodes. For example, some of the nodes (e.g., Node 1 20A, Node 2 20B) may be connected to a wired network interface, whereas others (e.g., Node 3 20C, Node 4 20D) may be connected wirelessly. In some aspects, the network may be password protected. Additionally, the server 25A may be connected to the network controller 700 via a different interface type than the nodes 20A-20N.

The controller interface 815 may include a serial interface such as USB and the controller interface 815 may be connected to the pulse shaper 108 (and processor 112). In other aspects, the network controller 700 may be remotely located from the transmitter 10 and the controller interface 315 includes a network interface. In some aspects of the disclosure, in a case where the network controller 700 is remote from the transmitter 10, the network controller 700 may issue a command to a local processor such as processor 112 to control the pulse shaper 108.

In an aspect of the disclosure, the network controller 700, nodes 20A-20N, server 25A and transmitter 10 may be time synchronized. This is to enable the server 25A to characterize the respective entangled pairs transmitted by the transmitter 10. In some aspects, the time may be synchronized by global positioning system (GPS), the precision time protocol (PTP) (including a high-accuracy version with White Rabbit™) or the network time protocol (NTP). Since the distance from a node (e.g., Node 1 20A) to the transmitter 10 may be different from distance from another node (e.g., Node 2 20B) to the transmitter 10, there may be a delay in receiving respective entangled pairs in the Node Pairs. This delay may be a priori known.

In some aspects, a reference signal transmitted from the server 25A or another element in the system may be used to share a clock or transmit a synchronization signal.

Each node 20A-20N may have the same configuration as the nodes described in U.S. application Ser. No. 19/312,767 filed Aug. 28, 2025, entitled “Quantum Communication Using Ultrabroadband Polarization-Frequency Hyperentangled Photons,” the description of which is incorporated by reference. For example, each node 20A-20N may comprise a polarization analyzer, a frequency analyzer, a photon detector(s), one or more processors and one or more network interface(s). Additionally, each 20A-20N may include a polarization detection and compensation module. In a case where the respective entangled pair is only entangled in polarization, a node may not include a frequency analyzer. Similarly, in a case where the respective entangled pair is only entangled in frequency, a node may not include the polarization analyzer.

The polarization analyzer is configured to perform the polarization projections. The polarization analyzer is in optical communication with the frequency analyzer such as via a single mode fiber. The frequency analyzer is configured to perform frequency projections on photons in a single polarization mode. The frequency analyzer is in optical communication with one or more photon detectors such as via a single mode fiber. The photon detector(s) may include superconducting nanowire detector(s).

One or more processors (in the nodes) are configured to control the projection settings for the polarization analyzer and the frequency analyzer based on instructions from the server 25A via one of the node's network interface(s). The polarization monitoring and compensation module may be positioned upstream of the polarization analyzer.

Polarization analyzer may comprise a collimator, a motorized quarter waveplate, a motorized half waveplate, a polarization beam splitter, and another collimator. Control of the waveplates realizes the different polarization projections. For two-photon polarization tomography, the system can execute either a standard 16-projection set or an overcomplete 36-projection set, the latter providing greater noise robustness through measurement redundancy at the expense of longer acquisition time. The number of projections may be application specific and based on a timing required for processing.

The frequency analyzer may comprise an electro-optic phase modulator (EOM) and a wavelength-selective switch(s) (WSS). The EOM is configured to selectively apply modulation to the frequency bins of the received photons in a single polarization mode. The EOM imposes a time-dependent phase modulation, thereby mixing and redistributing the amplitudes of the frequency bins. One or more processors may control the modulation based on frequency projections settings received from the server 25A. Like for the polarization projections, the control of the phase modulation may be based on the frequency encoding (d). The polarization analyzer and the frequency analyzer in each node may be controlled in a similar manner as described in U.S. application Ser. No. 19/312,767, the description of which is incorporated by reference, including for higher frequency encoding (d>2), the EOM is driven to implement a number of random phase shifts. For example, the modulation index may be randomly selected between 0 and 2.32 rads.

The EOM is driven using a RF generator, which may be co-located in each node or a reference RF signal may be provided via an RF over Fiber (RFoF). The frequency of the RF signal may be equal to the spacing between frequency bins.

One or more photon detectors are connected to an output port of the WSS whose input port is optically coupled to the EOM.

As described in U.S. application Ser. No. 19/312,767, the description of which is incorporated by reference, WSS may be controlled via the server 25A to selectively route frequency bins to specific ports as needed for the projections.

Each detector has a communications interface configured to communicate with the server 25A. The readout circuitry may generate a timestamp for each counted pulse and transmit the timestamp to the server 25A via a communications interface. The readout circuitry may include time taggers. The reference clock may be received by each component in the system, and the readout circuitry may derive the timestamp based on the reference clock. In some aspects, the timestamp may be a digital timestamp.

The server 25A may have the same configuration as the server described in U.S. application Ser. No. 19/312,767, the description of which is incorporated by reference. For example, the server 25A may comprise a processor, a memory, detector interfaces and network interface(s). The server 25A may be communicability connected with each node 20A-20N such as via a wired or wireless network interface.

The server 25A may communicate setting(s) for the polarization projections and/or the frequency projections to one or more processors in a respective node. Additionally, the server 25A may receive confirmation of the settings from the same. The server 25A also may communicate the bin connections for the output ports of the WSS to one or more processors in a respective node and receive confirmation of the same.

The server 25A may also be connected to the photon detector(s) (in each node) via a detector interface(s). In a case where each node 20A-20N has multiple photon detectors, there may be a dedicated connection for each photon detector.

The server 25A may also communicate with the network controller 700 via one of the network interface(s) 810. This communication may also be bi-directional. In an aspect of the disclosure, the server 25A may issue a request for a distribution of a respective entangled pair(s) for a particular Node Pair to the network controller 700 using one of the network interfaces 810. The server 25A may receive a response to the request from the network controller 700. The response may include confirmation of the requested distribution or an update to the request (e.g., a change). Alternatively, the request may come from the nodes 20A-20N and in this case, the server 25A may receive a notification of a distribution of a respective entangled pair(s) for a particular Node Pair from the network controller 700. Depending on the frequency encoding (d), the server 25A may issue instructions to the network controller 700 to control the pulse shaper 108.

In an aspect of the disclosure, the request may include an indication of whether the respective entangled pairs need to be polarization entangled, frequency entangled or both polarization and frequency entangled (hyperentangled). In other aspects, the request may indicate the application for the distribution, such as quantum key distribution (QKD), dense coding, entanglement distillation and/or teleportation (superdense teleportation). The network controller 700 may have stored default information for the type of entanglement (polarization entangled, frequency entangled or both polarization and frequency entangled (hyperentangled)) for each application.

In an aspect of the disclosure, the request may include an indication of a particular Bell State for the entanglement. The network controller 700 may select a device with sufficient capability—e.g., 1 state (such as available in the PIC 106), 2 states (such as available in the PIC 106A) or 4 states (such as available in the PIC 106B) to generate the requested state. For example, in some aspects of the disclosure, a single transmitter may have multiple PICs 106, 106A, 106B. In other aspects, there may be multiple transmitters 10, each with one of the PICs 106, 106A, 106B. In other aspects, the PICs 106B may be selectively controlled to provide the requested Bell State. In other aspects, the request may indicate the application for the distribution, such as quantum key distribution (QKD), dense coding, entanglement distillation and/or teleportation (superdense teleportation). The network controller 700 may have stored default information for the Bell State(s) for each application.

The server 25A may execute a program to perform quantum state tomography (QST) for quantum state characterization. In some aspects, a full QST may be estimated using Bayesian inference from the acquired polarization-frequency projections (using polarization projections when only polarization entanglement is used, or frequency projections when only frequency entanglement is used).

The server 25A may have stored the setting information for the polarization projections and/or frequency projections such as described in U.S. application Ser. No. 19/312,767, the description of which is incorporated by reference.

The server 25A may also store connection information for the photon detectors and the output ports of the WSS for the nodes associated with the server 25A. The connection information may be used to determine whether the server 25A needs to control the WSS to sequentially provide the projections to an output port to simultaneously provide the projections to multiple output ports.

The server 25A and/or the network controller 700 may store phase information for the pulse shaper 108. Depending on the target application and the algorithm used for QST, the pulse shaper 108 may be controlled to add a phase (phase shift) to each frequency bin. For example, for a specific QST, a set of random phases for each setting may be stored in the server 25A and/or the network controller 700.

The server 25A may also store coincidence count information. For example, for each polarization-frequency setting (combined projection setting), the processor (in the server 25A) determines a coincidence photon count. The processor stores the coincidence photon count in memory use in the quantum state characterization, such as in a table.

The server 25A may also store a mean density matrix which is the result of the QST, e.g., the determined quantum state. Additionally, the memory in the server 25A may serve as working memory for the processor in the server 25A to store each iteration of the Bayesian inference used for the quantum state characterization.

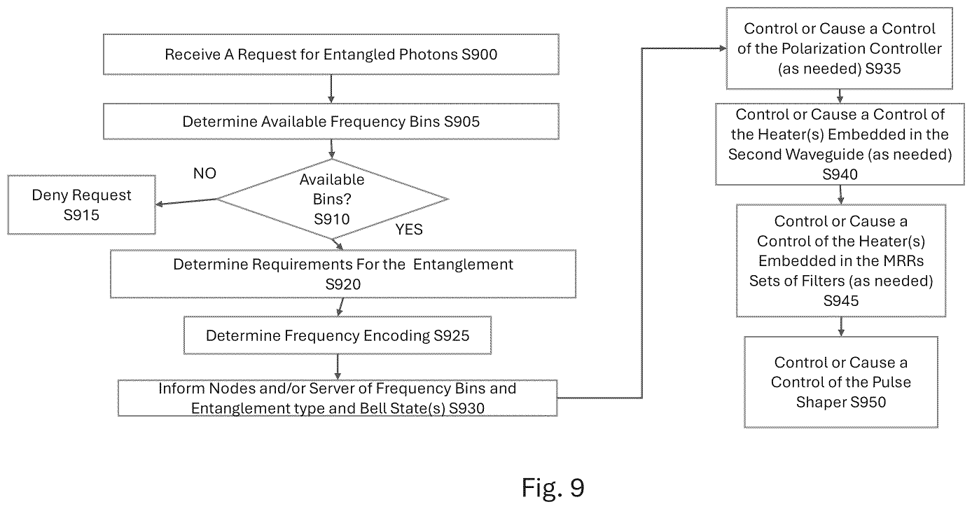

FIG. 9 illustrates an example of a method of distribution of respective entangled pairs in accordance with aspects of the disclosure. The method may be executed by a processor 800 in the network controller 700. As described above, in a case where the network controller 700 is in the transmitter, the processor 800 and the processor 112 may be the same. For the example described in FIG. 9, the transmitter 10 having the PIC 106B is referred to since the PIC 106B is capable of all four polarization Bell States. For a transmitter 10 having the PIC 106, S940, S945 may be omitted. For a transmitter 10 have the PIC 106B, S945 may be omitted.

At S900, the processor 800 receives a request for respective entangled pair(s). The request may be submitted by one node (e.g., Node 1 20A) of the Node Pair (e.g., Node 1 20A and Node 2 20B) or from the server 25A. The request may include a unique identifier identifying the nodes subject to the request. For example, the server 25A may transmit the request with two stored identifiers for a Node Pair.

In another aspect, the request may be received from each node in the node Pair (e.g., Node 1 20A, Node 2 20B). Each separate request may include the identifier of the node transmitting the request. This request may include a timestamp of the request. The timestamp may be used by the processor 800 to identify the Node Pair. For example, if two separate requests are received within a preset period of time, the requesting nodes may be deemed a Node Pair.

In some aspects of the disclosure, the request may include a desired frequency encoding (d_{d}). In a case where the request does not include the desired frequency encoding (d_{d}), a default frequency encoding (d_{def}) may be used in S925. Additionally, in an aspect of the disclosure, the request may be a specific request for a particular frequency bin(s). In some aspects, the frequency bins may be adjacent frequency bins. Alternatively, the request may be a general request for any frequency bin(s). As described above, the request may include an indication of the type of entanglement (polarization entangled, frequency entangled or both polarization and frequency entangled (hyperentangled)) and/or Bell State(s) or an application.

Since the request may be received prior to the nodes subject to the request being connected to output ports of the pulse shaper 108, the processor 800 may determine whether the nodes subject to the request are connected to an output port of the pulse shaper 108. If the nodes are not connected, the processor 800 may issue a notification to the server 25A. Additionally, in a case where there are multiple pairs of output ports, the processor 800 may identify which output ports the nodes subject to the request are connected to. For example, since the request(s) may include the unique identifier of the nodes in the Node Pair, the processor 800 uses these unique identifiers to match identifiers of connected nodes to the output ports. When there is a match, the processor 800 determines the port number associated with the match.

At S905, the processor 800 determines if there are any available frequency bins to satisfy the request. If the request is a general request for a certain number of bins with a desired frequency encoding (d_{d}), the processor 800 determines if the requested number of frequency bins is available. For example, in a case where the request is for a qubit frequency encoding (d_{d}=2), the processor 800 determines if two frequency bins in each band (e.g., C-band and L-band) are available such as by using a Status Table and the Entanglement Table (correspondence table). Similarly, in a case where the request is for a certain number of bins (where the frequency bins are specified (with a desired frequency encoding (d_{d})), the processor 800 determines if the specific frequency bins are available such as by referring to same. Additionally, as noted above, a default frequency encoding (d_{def}) may be used to determine the availability.

If there are no available frequency bins or not enough frequency bins available to satisfy the desired frequency encoding (d_{d}) or default frequency encoding (d_{def}) (“NO” at S910), the processor 800 may deny the request. For example, the processor 800 may transmit a notification to the sender(s) of the request, via the network interface 810, that the request cannot be satisfied. In other aspects, the request may be partially fulfilled under certain circumstances. For example, in a case where the request is for a high level of frequency encoding (d_{d}>=3) and if the processor 800 determines that there are available frequency bins to support a frequency encoding for a qubit frequency encoding (d=2), the processor 800 may issue a notification to the requestor(s), via the network interface 810, indicating the available for a reduced frequency encoding (d_{red}). The processor 800 may wait until a receipt of a response to the notification to continue the method.

In a case where there is availability to satisfy the full request or in a case where the processor 800 receives a response to the notification indicating that the partial fulfillment is acceptable, the processor 800 at S920 determines any requirements for the entanglement. The requirements may include the type of entanglement and Bell States. In a case where there is already network traffic, e.g., a distribution of respective entangled pairs, the type of entanglement may be maintained without disturbing the network traffic. In a case where there is no network traffic, the processor 800 may examine the request to see if a specific type of entanglement is requested. If there is a specific type of entanglement in the request, the processor 800 may set that type, e.g., polarization or frequency or both. In other aspects, in a case where there is no specific request for a type, but the request includes a specific application, the processor 800 may look up the type associated with the specific application and set the type.

Alternatively, in an aspect of the disclosure, if there is no specific requirement or an application identified in the request, a default type may be used. The default type may be hyperentanglement (both polarization and frequency).

Similarly, with respect to the Bell States, depending on the Bell State, in a case where there is already network traffic, e.g., a distribution of respective entangled pairs, the Bell State may be maintained. For example, in a case where the heater(s) 500 embedded in the second waveguide 205B are being controlled to impart a preset phase shift, the new distribution will also have the same phase shift.

In a case where all of the dual-MRRs (e.g., 400A, 400B, etc.) are being actively used to filter and perform path switching for specific frequencies, in the active traffic, the Bell States that require the path switches, e.g.,

$$\vert {Ψ}^{\pm } 〉 = \frac{1}{\sqrt{2}} \vert HV 〉 \pm \frac{1}{\sqrt{2}} \vert VH 〉$$

may not be available for other frequency-bin pairs. Existing network traffic may not be disturbed. In other aspects, there may be a priority for certain requests and existing network traffic may be disturbed in order to fulfill a higher priority request.

In a case where there is no network traffic, the processor 800 may examine the request to see if one or more specific Bell States are requested. If there is a specific Bell State(s) in the request, the processor 800 may set that Bell State(s). In other aspects, in a case where there is no specific request for Bell State(s), but the request includes a specific application, the processor 800 may look up the Bell State(s), associated with the specific application and set the same. Alternatively, in an aspect of the disclosure, if there is no specific requirement or an application identified in the request, a default Bell State may be used.

At S925, the processor 800 confirms the frequency encoding either the desired frequency encoding (d_{d}) or reduced frequency encoding (d_{red}).

At S930, the processor 800 may transmit a notification to the nodes subject to the request and/or the server 25A of the confirmed frequency encoding (d), the specific frequency bins being transmitted, the entanglement type and the Bell State(s). This information is used by the server 25A to coordinate the acquisition of the polarization, frequency or polarization-frequency projections.

At S935, the processor 800 controls or causes the control of the polarization controller to apply the set type of entanglement. For example, in a case where there is active network traffic, the control may be to maintain the polarization mode(s), as is, such as having both the first polarization mode and the second polarization mode being input into the PIC 106B. However, in a case where the polarization mode needs to be changed, the processor 800 may cause the polarization controller 104 to rotate the polarization mode, e.g., such that either the first polarization mode or the second polarization mode is input to the PIC 106B. Alternatively, the processor 800 may cause polarization controller 104 to rotate the polarization mode, e.g., from only either the first polarization mode or the second polarization mode to having a component of both polarization modes.

The processor 800 may cause the control by sending a control signal to the processor 112.

At S940 and S945, the processor 800 controls or causes the control of the set Bell State(s) to be output to the pulse shaper 108. For example, in a case where a Bell State of

$$\vert {Φ}^{-} 〉 = \frac{1}{\sqrt{2}} \vert HH 〉 - \frac{1}{\sqrt{2}} \vert VV 〉 or \vert {Ψ}^{-} 〉 = \frac{1}{\sqrt{2}} \vert HV 〉 - \frac{1}{\sqrt{2}} \vert VH 〉$$

is set at S920, the processor 800 controls or causes the control of the heater(s) 500 embedded in the second waveguide 205B to change the temperature of the second waveguide 205B to impart the preset phase shift. Alternatively, in a case where a Bell State of

$$\vert {Φ}^{+} 〉 = \frac{1}{\sqrt{2}} \vert HH 〉 + \frac{1}{\sqrt{2}} \vert VV 〉 or \vert {Ψ}^{+} 〉 = \frac{1}{\sqrt{2}} \vert HV 〉 + \frac{1}{\sqrt{2}} \vert VH 〉$$

is set at S920, the processor 800 controls or causes the control of the heater(s) 500 embedded in the second waveguide 205B to change the temperature of the second waveguide 205B to stop imparting the preset phase shift.

In a case where a Bell State of

$$\vert {Ψ}^{\pm } 〉 = \frac{1}{\sqrt{2}} \vert HV 〉 \pm \frac{1}{\sqrt{2}} \vert VH 〉$$

is set at S920, the processor 800 controls or causes the control of the heater(s) 500 embedded in the MRRs sets (e.g., 400A, 400B) to be tuned to the wavelength/frequency of either the signal mode or idler mode of one or more respective entangled pair(s) (allocated for distribution) at S945. Similar to above, the processor 800 may cause the control by sending a control signal to the processor 112.

At S950, the processor 800 may control or cause the control of the pulse shaper 108, via the controller interface 815 (or a network interface), to distribute the of respective entangled pairs using determined frequency bins and the confirmed frequency encoding (d).

In an aspect of the disclosure, the server 25A may receive from either the transmitter 10 or the network controller 700 an ideal quantum state for comparison (e.g., determining the fidelity). The ideal quantum state may be in the form of a mean density matrix.

The control of the Node Pairs to acquire the projections (e.g., polarization-frequency projections) and acquisition thereof is the same as described in U.S. application Ser. No. 19/312,767, the description of which is incorporated by reference. To acquire polarization only projections, the polarization analyzer may be separately controlled. Similarly, to acquire frequency only projections, the frequency analyzer may be separately controlled.

The processor in the server 25A performs QST to characterize the quantum state based on coincidence photon counts for the projection.

The processor in the server 25A may receive the results of the photon detections from the photon detectors in each node of the Node Pair. The “results” may be in the form of timestamps of each detection. Each detection is associated with a timestamp. After the combined settings have been executed, the processor in the server 25A groups determined coincidence counts for a predetermined period of time, e.g., integration time. For example, the predetermined period of time may be 60 seconds, however, the period of time is not limited thereto, for coincidence detections. The processor in the server 25A determines that the detection is “coincidence” if a photon is received by each node within a predetermined coincidence window (typically on the order of picoseconds or nanoseconds). For example, if 100 timestamps are received from a photon detector from a first node in a Node Pair (e.g., Node 1 20A) and 50 timestamps are received from a photon detector from a second node in the Node Pair (e.g., Node 2 20B) in the integration time, the coincidence photon count may be 50 (assuming each of the 50 timestamps from both nodes are within the predetermined coincidence window).

In an aspect of the disclosure, the processor in the server 25A uses a Bayesian inference algorithm to determine the quantum state, which relies on Bayes' theorem to define a posterior probability distribution for the unknown quantum state conditioned on the observed measurements. By sampling from this distribution with Markov chain Monte Carlo (MCMC) techniques, it is possible to estimate any quantity of interest, such as the mean and standard deviation of any function of the density matrix (the mathematical description of the quantum state).

At each iteration (available projections), the processor in the server 25A uses the data obtained so far to define the posterior probability distribution and sample from it via MCMC to obtain the estimates of interest. As more projections, and therefore coincidence counts become available, the error in the state estimate decreases.

Once the full quantum state of the source, e.g., transmitter 10, has been characterized using the QST, the characterization need not be repeated each time the respective entangled pairs are distributed. In some aspects, the full characterization may be periodically repeated or repeated as needed.

For QKD, the nodes in the Node Pair may also be communicably coupled, such as via a fiber optic cable. Each node may receive respective entangled pair(s) and perform selective measurements, e.g., polarization and/or frequency projections. In an aspect of the disclosure, multiple measurements may be acquired simultaneously (via multiple photon detectors). Each node notifies the other node in the Node Pair of the basis of the measurement such as via the fiber optic cable.

For dense coding, a first node (of the Node Pair) may receive one photon of its respective entangled pair and perform an operation on that photon. After performing the operation, the first node (of the Node Pair) transmits the newly encoded photon to the second node (of the Node Pair). In this aspect of the disclosure, the nodes in the Node Pair are communicatively coupled such as via a fiber optic cable. The second node (of the Node Pair) received the encoded photon from the first node while retaining the partner photon it previously received from the transmitter 10. The second node performs certain measurements of received photons (from the first node and the transmitter) and extracts bits of information. The number of bits is based on the frequency encoding. For higher levels of frequency encoding, the number of bits increases.

In superdense teleportation, for example, a controlled operation between the polarization and frequency DoFs of one photon, followed by a measurement, can be used to transfer or “teleport” a specific high-dimensional state to the other photon. Significantly, the use of multiple DoFs allows for this controlled operation to be performed deterministically with linear-optical components.

During the distribution of respective entangled pair(s), there may be noise in the fiber optic cable. The longer the distance between the transmitter 10 and the nodes, in general the more impact on the respective entangled pair(s). The nodes may perform entanglement distillation via local operations and classical communication. In some aspects, the local operations include a polarization-frequency CNOT applied bilaterally, followed by measurement and post-selection, to produce fewer, higher-fidelity pairs for subsequent use or re-transmission. Entanglement distillation may be used in a case where the node is a quantum repeater.

The application may dictate the duration of the distribution (in time) of respective entangled pair(s) and connection of the Node Pair to the pulse shaper 108. For example, QKD may use multiple respective entangled pair(s), where the number may be based on the length of the quantum-based secret key. In an aspect of the disclosure, once the quantum-based secret key, for each node (e.g., Node 1 20A, Node 2 20B) of the Node Pair, is generated and confirmed, the processor 800 may cause the pulse shaper 108 to stop the distribution to the Node Pair. In some aspects, the network controller 700 will instruct the receivers in the Node Pair to disconnect from the respective output port of the pulse shaper 108. After disconnection, the processor 800 updates the status information and the allocation information.

Each different application may have a preset distribution time stored in memory 805. When the distribution begins, the processor 800 may set a timer to the preset distribution time for the specified application. Once the timer expires, the processor 800 may cause the pulse shaper 108 to stop the distribution of the respective entangled pair(s) to the Node Pair and update the allocation to “available”. Once the timer expires, the Node (e.g., Node 1 20A or Node 2 20B) may issue a renewed request. In other aspects of the disclosure, one or both of the nodes in the Node Pair may transmit an end notification to the processor 800 in the network controller 700 via the network interface(s) 810. In response to receiving the end notification, the processor 800 may cause the pulse shaper 108 to stop the distribution. For example, the processor 800 may issue a different filtering instruction.

In FIGS. 1 and 7, a single dashed line represents control or detections, and a thin solid line represents a fiber optic cable such as a single mode fiber optic cable.

References in the specification to “one aspect”, “certain aspects”, “some aspects” or “an aspect”, indicate that the aspect(s) described may include a particular feature or characteristic, but every aspect may not necessarily include the particular feature, structure, or characteristic. Moreover, such phrases are not necessarily referring to the same aspect.

Aspects of the present disclosure may be implemented and run on a general-purpose computer or special-purpose computer system. The computer system may be any type known or will be known systems and may include a hardware processor, memory device, a storage device, input/output devices, internal buses, and/or a communications interface for communicating with other computer systems in conjunction with communication hardware and software, etc.

Various aspects of the present disclosure may be embodied as a program, software, or computer instructions embodied or stored in a computer or machine-usable or readable medium, or a group of media which causes the computer or machine to perform the steps of the method when executed on the computer, processor, and/or machine. A program storage device readable by a machine, e.g., a computer-readable medium, tangibly embodying a program of instructions executable by the machine to perform various functionalities and methods described in the present disclosure is also provided, e.g., a computer program product.

The computer-readable medium could be a computer-readable storage device or a computer-readable signal medium. A computer-readable storage device may be, for example, a magnetic, optical, electronic, electromagnetic, infrared, or semiconductor system, apparatus, or device, or any suitable combination of the foregoing; however, the computer-readable storage device is not limited to these examples except a computer-readable storage device excludes computer-readable signal medium. Additional examples of the computer-readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an optical storage device, or any appropriate combination of the foregoing; however, the computer-readable storage device is also not limited to these examples. Any tangible medium that can contain, or store, a program for use by or in connection with an instruction execution system, apparatus, or device could be a computer-readable storage device.

A computer-readable signal medium may include a propagated data signal with computer-readable program code embodied therein, such as, but not limited to, in baseband or as part of a carrier wave. A propagated signal may take any of a plurality of forms, including, but not limited to, electro-magnetic, optical, or any suitable combination thereof. A computer-readable signal medium may be any computer-readable medium (exclusive of computer-readable storage device) that can communicate, propagate, or transport a program for use by or in connection with a system, apparatus, or device. Program code embodied on a computer-readable signal medium may be transmitted using any appropriate medium, including but not limited to wireless, wired, optical fiber cable, RF, etc., or any suitable combination of the foregoing.

The terms “computer system” and “network” as may be used in the present application may include a variety of combinations of fixed and/or portable computer hardware, software, peripherals, mobile, and storage devices. The computer system may include a plurality of individual components that are networked or otherwise linked to perform collaboratively or may include one or more stand-alone components. The hardware and software components of the computer system of the present application may include and may be included within fixed and portable devices such as mobile phone, tablet, smartphone, desktop, laptop, and/or server. A module may be a component of a device, software, program, or system that implements some “functionality”, which can be embodied as software, hardware, firmware, electronic circuitry, or etc.

As used herein, the term “processor” may include a single core processor, a multi-core processor, multiple processors located in a single device, or multiple processors in wired or wireless communication with each other and distributed over a network of devices, the Internet, or the cloud. Accordingly, as used herein, functions, features or instructions performed or configured to be performed by a “processor”, may include the performance of the functions, features or instructions by a single core processor, may include performance of the functions, features or instructions collectively or collaboratively by multiple cores of a multi-core processor, or may include performance of the functions, features or instructions collectively or collaboratively by multiple processors, where each processor or core is not required to perform every function, feature or instruction individually. For example, multiple processors may allow load balancing. As used herein, the term “processor” may be replaced with the term “circuit”. The term “processor” may refer to, be part of, or include processor hardware (shared, dedicated, or group) that executes code and memory hardware (shared, dedicated, or group) that stores code executed by the processor.

In the description and claims herein, the term “about” indicates that the value listed may be somewhat altered, as long as the alteration does not result in nonconformance of the process or device. For example, for some elements the term “about” can refer to a variation of 0.1%, for other elements, the term “about” can refer to a variation of ±1% or ±10%, or any point therein. For example, the term about when used for a measurement in mm, may include +/0.1, 0.2, 0.3, etc., where the difference between the stated number may be larger when the state number is larger. For example, about 1.5 may include 1.2-1.8, where about 20, may include 19.0-21.0.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

The terminology used herein is for the purpose of describing particular aspects only and is not intended to be limiting the scope of the disclosure and is not intended to be exhaustive. Many modifications and variations will be apparent to those of ordinary skill in the art without departing from the scope and spirit of the disclosure.

What is claimed is:

1. A photonic integrated circuit (PIC) comprising:
a microring resonator (MRR) configured to:
receive first pump having a first polarization mode, the first pump having a pump frequency f_{P} that matches a resonant frequency of the MRR, the MRR configured to guide the first pump in a first direction through the MRR;
produce, from the first pump, respective first frequency-correlated photon pairs via a nonlinear optical interaction supported by the MRR, subject to energy conservation, each respective first frequency-correlated photon pair having signal mode with a signal frequency f_{S} and idler mode having an idler frequency f_{I}, and guide them in the first direction through the MRR,
receive second pump having the first polarization, the second pump having the pump frequency f_{P}, the MRR configured to guide the second pump in a second direction through the MRR, the second direction being opposite to the first direction; and
produce, from the second pump, respective second frequency-correlated photon pairs via the nonlinear optical interaction supported by the MRR, subject to energy conservation, each respective second frequency-correlated photon pair having a signal mode with the signal mode frequency f_{S} and idler mode having the idler mode frequency f_{I}, and guide them in the second direction through the MRR;
a first waveguide disposed upstream from the MRR, the first waveguide being evanescently coupled to the MRR, the first waveguide is configured to transfer the first pump and the second pump to the MRR, wherein the first pump propagates in the second direction within the first waveguide and the second pump propagates in the first direction within the first waveguide;
a second waveguide disposed downstream from the MRR, the second waveguide being evanescently coupled to the MRR, the second waveguide configured to:
receive the respective first frequency-correlated photon pairs from the MRR and guide them in the second direction through the second waveguide; and
receive the respective second frequency-correlated photon pairs from the MRR and guide them in the first direction through the second waveguide; and
a polarization splitter rotator (PSR) arranged and configured to
receive, from the second waveguide, the respective first and second frequency-correlated photon pairs comprising respective signal and idler modes, apply a common polarization rotation to photons of either the respective first or second frequency-correlated photon pairs in a polarization basis comprising mutually orthogonal polarization modes such that the signal and idler within each pair share the same polarization and the polarization mode of the respective first frequency-correlated photon pairs is orthogonal to the respective second frequency-correlated photon pairs, and
combine, post-rotation, all pairs to output a first polarization-entangled Bell State.

2. The PIC of claim 1, further comprising:
a second PSR arranged and configured to receive a pump having a first polarization-component and a second polarization-component different from the first polarization-component, split the pump received into first and second optical paths, rotate the polarization of light in the second optical path so that both the first optical path and the second optical path have light with identical polarization and provide, as the first pump and the second pump, outputs of the first optical path and the second optical path to opposite ends of the first waveguide.

3. The PIC of claim 1, further comprising:
a splitter selected from a group consisting of a Y-branch splitter and a Mach-Zehnder interferometer (MZI) coupler, the splitter being arranged and configured to receive pump and split the pump received into the first pump and the second pump in respective optical paths, preserve the polarization such that the first and second pump have identical polarization, and provide the first pump and the second pump to the first waveguide.

4. The PIC of claim 1, further comprising:
a heater embedded in either the first waveguide or the second waveguide and a processor configured to selectively control the heater to impart a preset phase shift to either the respective first or second frequency-correlated photon pairs, whereby based on the control, the PSR outputs either the first polarization-entangled Bell State or a second polarization-entangled Bell State.

5. The PIC of claim 1, further comprising:
at least two dual-MRRs disposed inside the second waveguide, each dual-MRR having a pair of MRRs between a first portion and a second portion of the second waveguide, each MRR being evanescently coupled to the second waveguide,
the at least two dual-MRRs comprise a first dual-MRR and a second dual-MRR,
the first dual-MRR comprising a first MRR and a second MRR, each tuned to a selected frequency corresponding to one mode of a first frequency-correlated photon pair and equal to a corresponding mode frequency of a second frequency-correlated photon pair; the first dual MRR being configured to (i) couple light at the selected frequency from a first portion of the second waveguide to a second portion via the first and second MRRs, thereby reversing a propagation direction of that mode in the first frequency-correlated photon pair; and (ii) couple light at the same selected frequency from the second portion to the first portion via the second and first MRRs, thereby reversing the propagation direction of that mode in the second frequency-correlated photon pair; whereby traffic at the selected frequency is exchanged between the first and second portions, and
the second dual-MRR comprising a third MRR and a fourth MRR, each tuned to a another selected frequency corresponding to one mode of a first frequency-correlated photon pair and equal to a corresponding mode frequency of a second frequency-correlated photon pair; the second dual-MRR being configured to (i) couple light at the another selected frequency from a first portion of the second waveguide to a second portion via the third and fourth MRRs, thereby reversing a propagation direction of that mode in the first frequency-correlated photon pair; and (ii) couple light at the same another selected frequency from the second portion to the first portion via the fourth and third MRRs, thereby reversing the propagation direction of that mode in the second frequency-correlated photon pair; whereby traffic at the another selected frequency is exchanged between the first and second portions.

6. The PIC of claim 5, wherein the PSR receives, after the reversal, the respective first and second frequency-correlated photon pairs with respective signal and idler mode and applies the common polarization rotation to the photons either the respective first or second frequency-correlated photon pairs in a polarization basis comprising mutually orthogonal polarization modes such that for the selected frequency and another selected frequency, the signal and idler mode within each pair have a different polarization mode for both the respective first and second frequency-correlated photon pairs and for other frequencies, the signal and idler mode within each pair share the same polarization mode and the polarization mode of the respective first frequency-correlated photon pairs is orthogonal to the respective second frequency-correlated photon pairs and combine, post-rotation and reversal, all pairs to output both a first polarization-entangled Bell State and a second polarization-entangled Bell State, where the second polarization-entangled Bell State comprises the selected frequency and the another selected frequency.

7. The PIC of claim 6, where the first MRR, the second MRR, the third MRR and the fourth MRR are respectively tuned using a dedicated heater.

8. The PIC of claim 6, further comprising:
a heater embedded in either the first waveguide or the second waveguide and a processor configured to selectively control the heater to impart a preset phase shift to either the respective first or second frequency-correlated photon pairs, whereby based on the control, the PSR outputs one or more polarization-entangled Bell States.

9. A quantum transmitter comprising:
the PIC of claim 1;
a pump laser configured to emit a pump at the resonant frequency of the MRR; and
a polarization controller disposed between the pump laser and the PIC, the polarization controller configured to rotate the polarization of the pump laser and provide to the PIC the pump with a target polarization.

10. The quantum transmitter of claim 9, further comprising:
a feedback module configured to monitor a power of light issued from the PIC at a particular frequency, and
a processor configured to maintain a match of the frequency of the pump laser with a resonant frequency of the MRR.

11. The quantum transmitter of claim 10, wherein the processor is configured to (1) adjust a frequency of the pump laser based on the power monitored or (2) adjust a resonant frequency of the MRR based on the power monitored.

12. The quantum transmitter of claim 11, further comprising:
a heater arranged and configured to heat the MRR to adjust the resonant frequency under the control of the processor.

13. The quantum transmitter of claim 9, further comprising:
a first optical filter array arranged between the pump laser and the PIC, the first optical filter array is configured to filter the pump to have a predefined frequency band centered at the frequency of the pump laser.

14. The quantum transmitter of claim 13, further comprising:
a second optical filter array arranged at an output of the PIC, the second optical filter array configured to remove the pump from issued light.

15. The quantum transmitter of claim 14, wherein the first optical filter array and the second optical filter array comprise a plurality of Dense Wavelength Division Multiplexing (DWDM) elements.

16. The quantum transmitter of claim 14, further comprising:
a router module comprising signal mode output ports and idler mode output ports, the router module configured to:
receive light issued by the PIC;
route portions of the issued light having signal mode frequencies f_{S} to the signal mode output ports, and
route portions of the issued light having idler mode frequencies f_{I} to the idler mode output ports.

17. The quantum transmitter of claim 16, further comprising:
a processor configured to control the router module to deliver two or more signal mode frequencies f_{S} to a first node and two or more idler mode frequencies f_{I} to a second node which are entangled.

18. The quantum transmitter of claim 16, wherein the router module comprises at least one pulse shaper.

19. A network comprising
the quantum transmitter of claim 17, wherein the first node and the second node are configured to communicate with each other based on quantum key distribution (QKD) using the two or more signal mode frequencies f_{S} and the two or more idler mode frequencies f_{I}.

20. A network comprising
the quantum transmitter of claim 17, wherein the first node and the second node are configured to perform dense coding using the two or more signal mode frequencies f_{S} and the two or more idler mode frequencies f_{I}.

21. A network comprising
the quantum transmitter of claim 17, wherein the first node and the second node are configured to perform superdense teleportation using the two or more signal mode frequencies f_{S} and the two or more idler mode frequencies f_{I}.

22. A network comprising
the quantum transmitter of claim 17, wherein the first node and the second node are configured to perform entanglement distillation using the two or more signal mode frequencies f_{S} and the two or more idler mode frequencies f_{I}.

23. The PIC of claim 1, wherein the nonlinear optical interaction comprises spontaneous four-wave mixing.

24. The PIC of claim 2, wherein the splitter is configured to implement a tunable power-splitting ratio.
